(19) United States
(12) Patent Application Publication
(10) Pub. No.: US 2007/0000217 A1
(43) Pub. Date: Jan. 4, 2007

(54) Apparatus to free a bull rider

(76) Inventor: Laurence Arthur Waldroup, Kirtland, NM (US)

Correspondence Address: Laurence Arthur Waldroup, 4130 HWY 64, Kirtland, NM, 87417, US

(21) Appl. No.: 11/172,494

(22) Filed: Jun. 29, 2005

(51) Int. Cl. B68B 1/00

(52) U.S. Cl. 54/1

(57) ABSTRACT

A apparatus to free a bull rider from a bucking bull when he is hung in his bull rope and can not free himself with a safety latch with a fluorescent strap attached to the release handle, attaches to any brand of bull rope, and a release responsive to the pulling of the fluorescent strap to release the safety latch.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of safety and more specifically to a apparatus to free a bull rider from a bucking bull when he is hung in his bull rope and can not free himself.

bull riding has always been a dangerous sport and has always been plagued by the bull rider getting thrown off of the bull and getting hung in his bull rope and being unable to free himself. Methods for freeing the bull rider was limited to the bull fighter jumping on the bulls back and grabbing the tail of the bull rope and jerking on it in an attempt to free the bull riders hand from the rope.

As of this time there is no technology available.

No prior technology

### BRIEF SUMMARY OF THE INVENTION

The primary object of the invention is to provide a safe way to free a bull rider who is hung up in his bull rope from a bucking bull.

Another object of the invention is to provide a apparatus that will not interfere with a bull riders ability to ride a bucking bull.

Another object of the invention is to provide a apparatus that will allow a bull fighter to quickly and safely free a bull rider that is hung in his rope.

A further object of the invention is to provide a apparatus that will not affect a bulls ability to perform at his best.

Yet another object of the invention is to provide a apparatus that is adaptable to all different types of bull ropes with out any modifications.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a apparatus to free a bull rider from a bucking bull when he is hung in his bull rope and can not free himself comprising: a safety latch with a fluorescent strap attached to the release handle, attaches to any brand of bull rope, and a release means responsive to the pulling of the fluorescent strap to release the safety latch.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is an elevation view of the invention.

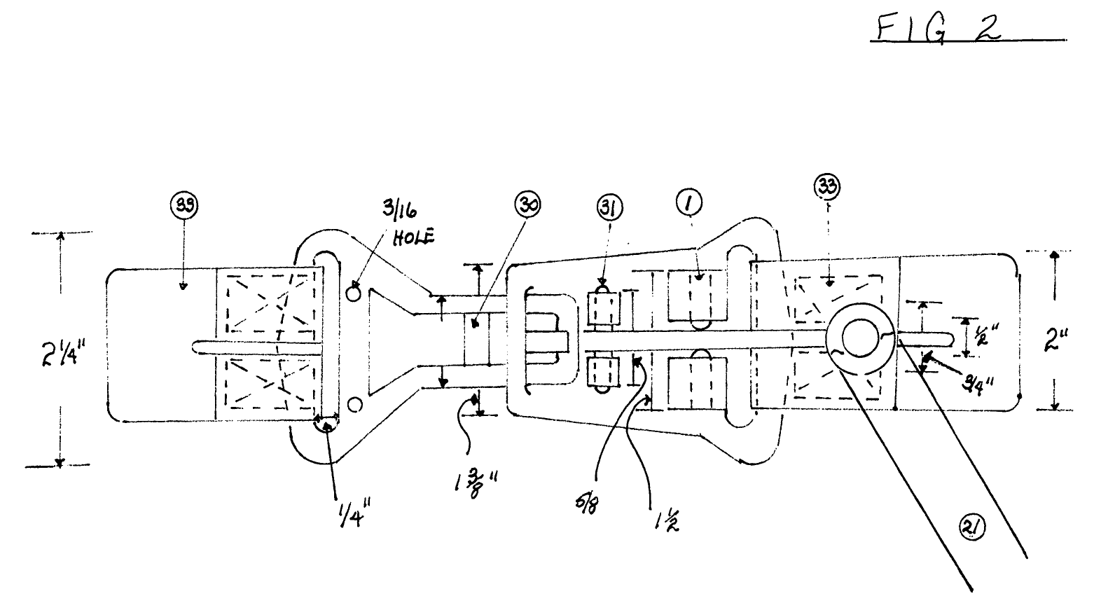

FIG. 3 is a back view of the invention.

FIG. 4 is a side view of the invention.

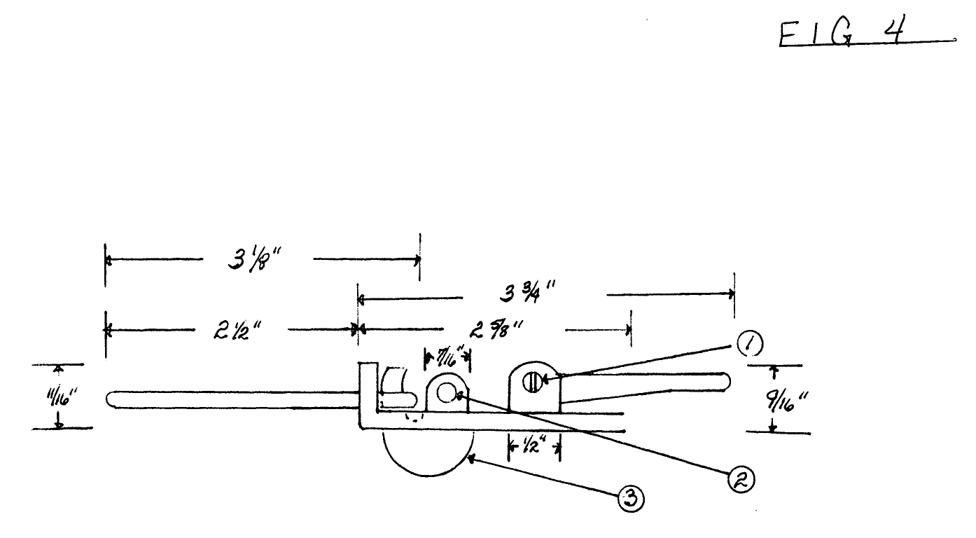

FIG. 5 is a side view of the invention in an open position.

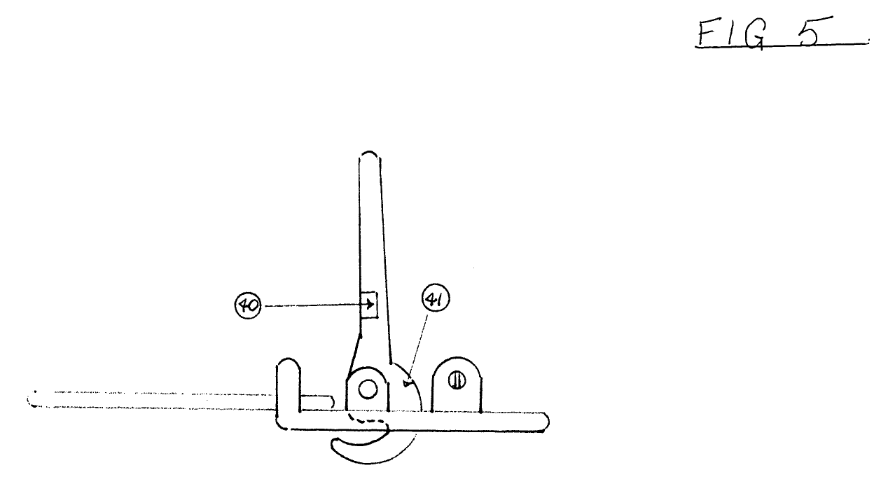

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Turning first to page 1 shows the safety latch and receiver inside the leather pouch, FIG. 21 shows the fluorescent strap that is attached to the release handle.

FIG. 22 shows the split in the leather pouch that allows the strap to be pulled on and the latch opened.

FIG. 23 is a hole in the leather to facilitate the nose of the safety latch handle. In order for the safety latch to be opened the fluorescent strap must be pulled down thru the split in the leather pouch, pulling the handle that opens the latch downward allowing the safety latch to be disengaged from the receiver thus breaking the continuity of the bull rope and freeing the bull rider from the bucking bull. It is of great importance with the simplicity of the apparatus in that the chances of it failing are almost nil, and that anybody can pull the safety strap and the latch will open even if the latch is under pressure. This allows the bull rider to be freed quickly, therefore greatly reducing there chances of serious injuries. When a bull rider gets hung in his bull rope, the bucking bulls which are quite valuable, all so stand to be injured, the bull fighters have to put them self's in great danger because it is there job to get the bull rider free from his rope and free from the bull, they do this by compromising there own well being in order to do there job.

Turning to page 2 FIGS. 30,31,1 demonstrate some of the make up of the latch and receiver FIG. 21 show the fluorescent strap attachment to the the release handle

FIG. 33 shows the attachment of the nylon straps to each end of the latch and receiver

Turning to page 3 FIG. 10 demonstrates the machine stitching of the protective leather pouch

FIG. 11 shows the nylon straps extending out side of the leather pouch

FIG. 12 is a slot cut in the leather pouch to allow for the cam lock to function freely

FIG. 13 shows the rivets that fasten the receiver to the leather pouch so that when the latch is released the receiver will stay inside the pouch

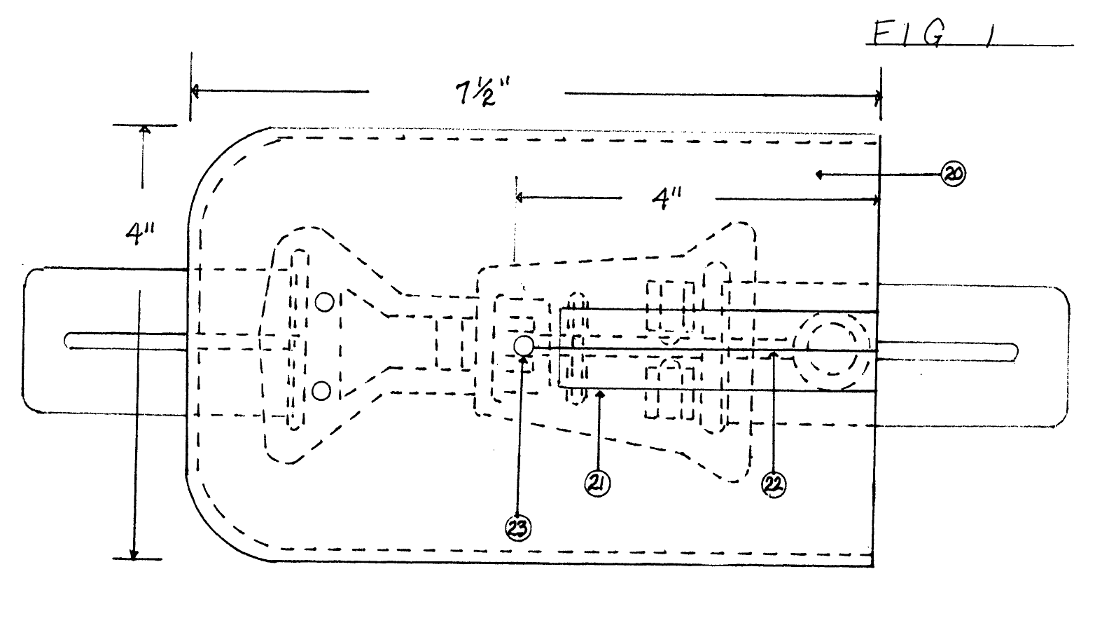

Turning to page 4 FIG. 1 is the hardened tension screw that hold the pressure on the release handle to keep it shut until the handle is pulled on

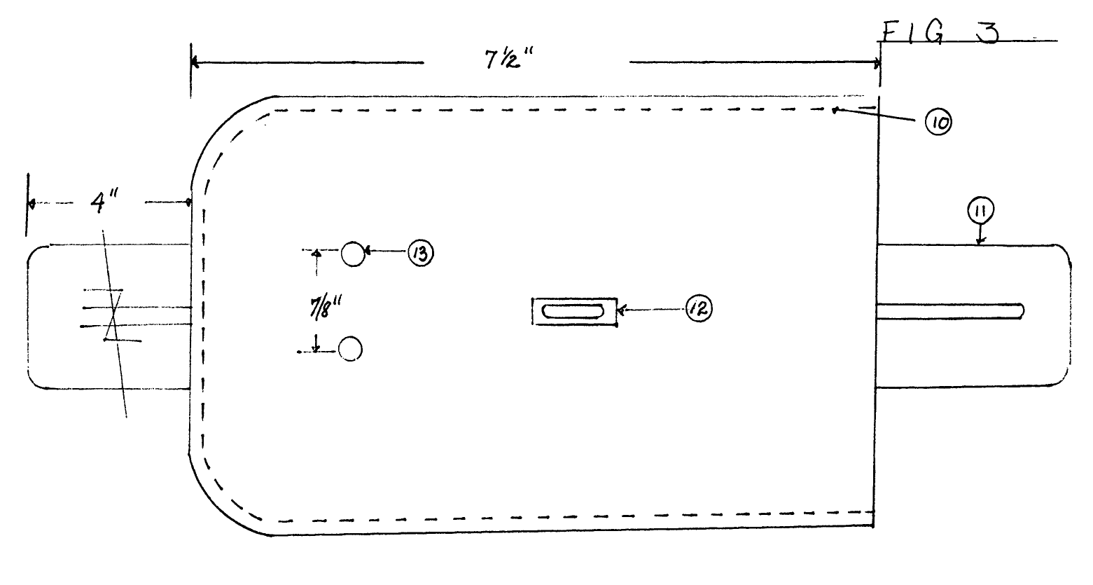

FIG. 3 demonstrates how the cam lock is passed thru the receiver to keep the two pieces attached together

Turning to page 5 the side view shows how the latch and receiver appear when they are in the position to be separated from each other

FIG. 40 is an indentation to accept the tension screw that hold pressure on the handle to keep the mechanism closed

FIG. 41 shows the position the cam lock and lever need to be, in order for the latch to be separated from the receiver.

This safety device will provide the quickest, easiest and most efficient means of freeing a bull rider who has gotten hung up in his bull rope and can not free himself, it will reduce the chances of the bull fighter getting injured because he will no longer have to jump up on the bulls back trying to jerk the tail of the bull rope to free the bull rider from his rope and the bucking bull, but now all he will have to do is run along side of the bucking bull and jerk on the fluorescent strap to unlock the safety latch breaking the continuity of the bull rope freeing the bull rider, this in turn will allow the bull to return to his pen without injury.

This safety device comprising of a high quality latch and receiver, attaches to any brand of bull rope without any modification and is responsive to any person that can pull on the strap that is attached to the cam lock and lever that separates the latch from the receiver.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A apparatus to free a bull rider from a bucking bull when he is hung in his bull rope and can not free himself comprising:
a safety latch with a fluorescent strap attached to the release handle;
attaches to any brand of bull rope; and
a release means responsive to the pulling of the fluorescent strap to release the safety latch.
